(19) United States
(12) Patent Application Publication
(10) Pub. No.: US 2009/0133119 A1
(43) Pub. Date: May 21, 2009

(54) MASTER DEVICE AND DATA PROCESSING SYSTEM

(76) Inventors: Junji Kato, Tokyo (JP); Kazuo Tashiro, Tokyo (JP)

Correspondence Address: MILES & STOCKBRIDGE PC, 1751 PINNACLE DRIVE, SUITE 500, MCLEAN, VA, 22102-3833, US

(21) Appl. No.: 12/299,014

(22) PCT Filed: May 15, 2006
(86) PCT No.: PCT/JP2006/309667

§ 371 Date: Oct. 29, 2008

(51) Int. Cl. H04L 9/32

(52) U.S. Cl. 726/17

(57) ABSTRACT

A certification result obtained by a master device 2 for a slave device 3 is notified to a master data processing device 6 while making a part of determination result data supplied from a master certification device 5 to the master data processing device 6 accompany with the rest of the determination result data supplied from the master certification device 5 to the master data processing device 6 through the slave device 3. Even when the part of the determination result data and the rest of the determination result data are plain text, they are given from different routes 11 and 10. Accordingly, the confidentiality for the determination result can be enhanced as compared to the case where all of the determination results are given from the master certification device 5 to the master data processing device 6. Thus, it is not necessary to enhance the confidentiality for the determination result of the certification process by allowing the master data processing device to execute an encryption/decryption processing program.

### TECHNICAL FIELD

The present invention relates to a master device which performs device certification relating to the validity of a detachable slave device, and to a data processing system including the master device and the slave device. The present invention also relates to a technique advantageous in applying to device certification performed by, for example, a PC (Personal Computer) for a battery and a removable storage, and device certification performed by an LBP (Laser Beam Printer) for a toner cartridge or a photoreceptor cartridge.

### BACKGROUND ART

In order to determine the validity of a slave device attached to a master device, a technique of device certification can be employed. A basic certification method used for device certification is described in Patent document 1. According to the document, its basic certification method is carried out in such a manner that a demonstrator demonstrates to a certifier that the demonstrator holds a secret function called a certification function, without letting know the function itself. Therefore, the certifier selects certain data (challenge data), and transmits the same to the demonstrator. In response thereto, the demonstrator converts the challenge data using the certification function, and returns the obtained data (response data) to the certifier. The certifier that receives the response data also shares the certification function, and converts the transmitted challenge data using the certification function held by the certifier so as to compare its result and the response data. If they are equal to each other, it is determined that the demonstrator holds the legitimate certification function, and certifies its validity. For example, when a slave device is attached, a master device issues a certification command to the slave device so as to allow the slave device to issue a first random number. The master device encrypts the first random number, and adds a different second random number to the encrypted first random number to be returned to the slave device. The slave device extracts the second random number therefrom, and encrypts the extracted data to be returned to the master device. The master device decrypts the encrypted second random number, and if the second random number can be obtained from the decrypted result, it is determined that the slave device is true and correct. The master device corresponds to the certifier, the slave device corresponds to the demonstrator, the second random number corresponds to the challenge data, and the encryption/decryption algorithm for the random number corresponds to the certification function.

Patent document 1: Japanese Unexamined Patent

### DISCLOSURE OF THE INVENTION

### Problem to be Solved by the Invention

The certification result of the master device is reflected on the subsequent controlling mode performed by the master device for the slave device. The master device uses a data processor for its internal control and interface control with respect to the slave device. Such a data processor generally performs data processing without confidentiality. If device certification is performed using the data processor that performs data processing without confidentiality, the algorithm for generating a random number and the algorithm for encryption and decryption are possibly analyzed with ease. Therefore, it is preferable to use an individual chip (certification chip), for the process of generating a random number and the process of encryption and decryption, in which the confidentiality for internal operations is enhanced. At this time, a certification result obtained by the certification chip has to be naturally notified to the data processor that performs data processing without confidentiality. If the certification result is notified by using simple plain-text code data, the meaning and content thereof can be easily analyzed. Accordingly, even if the certification chip with confidentiality is used, there is a possibility that the effect achieved by using the individual chip is halved. Sophisticated encryption may be performed for the certification result. However, in order to perform the sophisticated encryption, it is necessary for the data processor used for internal control of the master device to execute a process of encryption and decryption. The process of encryption and decryption places a large burden on the data processor, and it is necessary to set aside a storage area for such a program, which results in a large burden on the master device in terms of data processing and capacity of a program memory.

An object of the present invention is to make it difficult to illegally analyze a device certification result without largely depending on a software process.

The foregoing and other objects, and novel characteristics of the present invention will be apparent from the description of the present specification and the appended drawings.

### Means for Solving the Problem

Summarized description of the representative outlines of the aspects of the present invention disclosed in this application is as follows.

### [1] <<Master Device>>

A slave device (3) is detachably coupled to a master device (2) according to the present invention. The master device includes a master certification device (5) which is used for a certification process for the coupled slave device, and a master data processing device (6) which enables interface control with respect to the coupled slave device and interface control with respect to the master certification device. The master certification device makes a true-false determination on a response which is returned from the slave device after responding to a command from the master data processing device, divides a true-false determination result into a plurality of pieces of determination result data in accordance with a predetermined algorithm, outputs a part of the divided determination result data to the slave device, and outputs the rest to the master data processing device. The master data processing device recognizes the determination result on the basis of the part of the determination result data which is returned from the slave device and the rest of the determination result data which is given from the master certification device.

According to the above-described means, the certification result obtained by the master device for the slave device is notified to the master data processing device while making a part of the determination result data supplied from the master certification device to the master data processing device accompany with the rest of the determination result data supplied from the master certification device to the master data processing device through the slave device. Even when the part of the determination result data and the rest of the determination result data are plain text, they are given from different routes. Accordingly, the confidentiality for the determination result can be enhanced as compared to the case where all of the determination results are given from the master certification device to the master data processing device. Thus, it is not necessary to enhance the confidentiality for the determination result of the certification process by allowing the master data processing device to execute an encryption/decryption processing program. Further, one of the different routes through which the determination result data are given to the master data processing device is provided inside the master device, and the both of the determination result data are not given to the master data processing device from the slave device. If the both are given to the master data processing device from the slave device, illegal replication or imitation can be done only on the side of the slave device as a demonstrator to be certified. Thus, the certification result that means approval can be fabricated and input to the master device irrespective of the actual certification result.

There are separately provided first transfer routes (13, 14) through which the part of the determination result data obtained by the master certification device is transferred to the slave device, and second transfer routes (10, 15) through which the part of the determination result data is returned from the slave device. The same determination result data do not pass through the same route, so that the confidentiality for the determination result data themselves can be enhanced.

The second transfer route is a general-purpose bus (10) through which a command from the master data processing device is transmitted and a response from the slave device responding to the command is transmitted. A different command or command response can be provided at the head or rear of the determination result data. In this respect, too, the confidentiality for the determination result data themselves can be enhanced.

The part of the determination result data which is returned from the slave device through the general-purpose bus may be accompanied with dummy data. Further, the part of the determination result data which is returned from the slave device through the general-purpose bus may be accompanied with a response to a different command. It becomes difficult to discriminate the part of the determination result data on the transfer route. When accompanying the dummy data and the different command response, it is obviously necessary that a predetermined algorithm shared by the master device and the slave device is performed to be satisfied.

### [2] <<Data Processing System>>

A data processing system according to the present invention includes a master device, and a slave device which is detachably coupled to the master device. The master device includes a master certification device which is used for a certification process for the coupled slave device, and a master data processing device which enables interface control with respect to the coupled slave device and interface control with respect to the master certification device. The master certification device makes a true-false determination on a response which is returned from the slave device after responding to a command from the master data processing device, divides a true-false determination result into a plurality of pieces of determination result data in accordance with a predetermined algorithm, outputs a part of the divided determination result data to the slave device, and outputs the rest to the master data processing device. The master data processing device recognizes the determination result on the basis of the part of the determination result data which is returned from the slave device and the rest of the determination result data which is given from the master certification device.

According to the data processing system, even when the part of the determination result data and the rest of the determination result data are plain text, they are given from different routes. Accordingly, the confidentiality for the determination result can be enhanced as compared to the case where all of the determination results are given from the master certification device to the master data processing device. Thus, it is not necessary to enhance the confidentiality for the determination result of the certification process by allowing the master data processing device to execute an encryption/decryption processing program.

The slave device may allow the part of the determination result data which is returned to the master device through the general-purpose bus to be accompanied with dummy data. Further, the slave device may allow the part of the determination result data which is returned to the slave device through the general-purpose bus to be accompanied with a response to a different command. It becomes difficult to discriminate the part of the determination result data on the transfer route. In this respect, the confidentiality for the determination result data themselves can be enhanced.

As a concrete configuration, the slave device includes a slave certification device (7) which is used for a certification process performed by the master device for the slave device, and a slave data processing device (8) which enables interface control with respect to the master device to which the slave device is coupled and interface control with respect to the slave certification device. In response to a first command (command issued in S7) from the master device, the slave certification device generates response data (data transmitted in S10), and the slave data processing device outputs the response data to the master device. In response to a second command (command issued in S16) from the master device, the slave certification device inputs a part of determination result data which are obtained by dividing a true-false determination result by the master device on the basis of the response data, and the slave data processing device returns the part of the determination result data to the master device.

As another concrete configuration of the slave device, in response to a second command from the master device, the slave certification device inputs a part of determination result data which are obtained by dividing a true-false determination result by the master device on the basis of the response data, and the slave certification device returns the part of the determination result data to the master device.

As still another concrete configuration of the slave device, in response to a second command from the master device, the slave data processing device inputs a part of determination result data which are obtained by dividing a true-false determination result by the master device on the basis of the response data, and the slave data processing device returns the part of the determination result data to the master device.

The slave device separately includes a first interface terminal to which the part of the divided determination result data is input from the master device, and a second interface terminal from which the part of the divided determination result data input from the first interface terminal is output to the master device. The same determination result data do not pass through the same route, so that the confidentiality for the determination result data themselves can be enhanced.

The second interface terminal is a general-purpose terminal which is used for inputting a command from the master device and for outputting a command response. A different command or command response can be provided at the head or rear of the determination result data. In this respect, too, the confidentiality for the determination result data themselves can be enhanced.

### [3] <<Data Processing System>>

A data processing system, according to the present invention from another viewpoint, includes a master device, a slave device which is detachably coupled to the master device, and a peripheral device (20) which can be coupled to the master device and the slave device. The master device includes a master certification device which is used for a certification process for the coupled slave device, and a master data processing device which enables interface control with respect to the coupled slave device and interface control with respect to the master certification device. The master certification device makes a true-false determination on a response which is returned from the slave device after responding to a command from the master data processing device, divides a true-false determination result into a plurality of pieces of determination result data in accordance with a predetermined algorithm, outputs a part of the divided determination result data to the peripheral device, and outputs the rest to the master data processing device. The peripheral device outputs the part of the divided determination result data to the slave device. The master data processing device recognizes the determination result on the basis of the part of the determination result data which is returned from the slave device and the rest of the determination result data which is given from the master certification device. By providing the peripheral circuit on the transfer route through which the part of the divided determination result data is transmitted from the master device to the slave device, the route becomes more complicated. In this respect, the confidentiality for the determination result data themselves can be enhanced.

### [4] <<Master Device>>

A master device, according to the present invention from another viewpoint, to which a slave device is detachably coupled includes a master certification device (5) which generates and converts certification data and makes a true-false determination on the certification data, and a master data processing device (6) which enables interface control with respect to the slave device and the master certification device. The master certification device makes a true-false determination on response data from the slave device responding to the generated certification data, divides a determination result into first and second determination result data, outputs the first determination result data to the slave device, and outputs the second determination result data to the master data processing device. The master data processing device recognizes the determination result on the basis of the first determination result data which are received from the slave device and the second determination result data which are received from the master certification device.

### [5]<<Data Processing System>>

A data processing system, according to the present invention from another viewpoint, includes a master device (2), and a slave device (3) which is detachably coupled to the master device. The master device includes a master certification device (5) which generates and converts certification data and makes a true-false determination on the certification data, and a master data processing device (6) which enables interface control with respect to the slave device and the master certification device. The slave device includes a slave certification device (7) which generates and converts certification data and makes a true-false determination on the certification data, and a slave data processing device (8) which enables interface control with respect to the master device and the slave certification device. The master certification device makes a true-false determination on conversion data which are returned after the generated certification data are converted by the slave certification device, divides a determination result into first and second determination result data, outputs the first determination result data to the slave device, and outputs the second determination result data to the master data processing device. The master data processing device recognizes the determination result on the basis of the first determination result data which are received from the slave device and the second determination result data which are received from the master certification device.

[6]<<Data Processing System>>

Another data processing system (1C), according to the present invention from a viewpoint of mutual certification, includes a master device (2A), and a slave device (3A) which is detachably coupled to the master device. The master device includes a master certification device (5A) which generates and converts certification data and makes a true-false determination on the certification data, and a master data processing device (6A) which enables interface control with respect to the slave device and the master certification device. The slave device includes a slave certification device (7A) which generates and converts certification data and makes a true-false determination on the certification data, and a slave data processing device (8A) which enables interface control with respect to the master device and the slave certification device. The slave certification device makes a true-false determination on first conversion data which are returned after generated first certification data are converted by the master certification device. The master certification device makes a true-false determination on second conversion data which are returned after generated second certification data are converted by the slave certification device. The master data processing device obtains a certification result for the slave device by performing an operation using a first true-false determination result obtained by the slave certification device for the first conversion data and a second true-false determination result obtained by the master certification device for the second conversion data.

According to the above-described means, although the certification performed by the master device for the slave device is mutually performed by a certification process performed by the slave device for the master device and a certification process performed by the master device for the slave device, it is possible for the master data processing device to obtain the certification result for the slave device by performing an operation using the true-false determination data results obtained by the respective certification processes. The respective pieces of true-false determination result data are serially given from different routes, and the both pieces of true-false determination result data are used for the final certification, so that the confidentiality for the determination result can be enhanced as compared to the mutual certification separately using the respective determination results. It is not necessary to enhance the confidentiality for the determination result of the certification process by allowing the master data processing device to execute the encryption/decryption processing program.

In the above-described means, the master data processing device may receive the true-false determination result from any element in the slave device. For example, the master data processing device may receive the true-false determination result from the slave data processing device. Specifically, the slave data processing device gives a first true-false determination result obtained by the slave certification device for the first conversion data to the master data processing device. The master data processing device obtains a certification result for the slave device by performing an operation using a second true-false determination result for the second conversion data which are received from the master certification device and the first true-false determination result which are received from the slave data processing device.

Still another data processing system, according to the present invention from a viewpoint of mutual certification, includes a master device (2A), and a slave device (3A) which is detachably coupled to the master device. The master device includes a master certification device (5A) which generates and converts certification data and makes a true-false determination on the certification data, and a master data processing device (6A) which enables interface control with respect to the slave device and the master certification device. The slave device includes a slave certification device (7A) which generates and converts certification data and makes a true-false determination on the certification data, and a slave data processing device (8A) which enables interface control with respect to the master device and the slave certification device. The master data processing device converts first certification data generated by the slave certification device at the master certification device, and adds second certification data generated by the master certification device to the converted first-conversion-data to be output to the slave data processing device. The slave processing device allows the slave certification device to make a true-false determination on the first conversion data of the first certification data and to convert the second certification data, and outputs the determined first-determination-result-data and the converted second-conversion-data to the master data processing device. The master data processing device allows the master certification device to make a true-false determination on the second conversion data of the second certification data, and obtains a determination result for the slave device on the basis of the determined second-determination-result-data and the determined first-determination-result-data. As similar to the above, the confidentiality for the determination result can be enhanced.

### EFFECT OF THE INVENTION

Summarized description of the effects obtained by the representative aspects of the present invention disclosed in this application is as follows.

That is, it is possible to make it difficult to illegally analyze a device certification result without largely depending on a software process.

### BRIEF DESCRIPTION OF THE DRAWINGS

FIG. 1 is a block diagram showing an example of a data processing system according to the present invention.

FIG. 2 is a flowchart showing a processing procedure of device certification performed by a master device for a slave device.

FIG. 3 is a block diagram showing another example of a data processing system.

FIG. 4 is a block diagram showing still another example of a data processing system.

FIG. 5 is a block diagram of a data processing system aiming at enhancing the confidentiality for a result of mutual certification.

FIG. 6 is a flowchart showing a device certification procedure in the data processing system of FIG. 5.

FIG. 7 is a block diagram showing an example of a data processing system in which the number of slave devices coupled to the master device is increased.

### DESCRIPTION OF REFERENCE NUMERALS

| 1, 1A, 1B, 1C | data processing system (SYS) |
|---|---|
| 2, 2A | master device (MST) |
| 3, 3A | slave device (SLV) |
| 5, 5A | master certification device (CTFm) |
| 6, 6A | master data processing device (CPUm) |
| 7, 7A | slave certification device (CTFs) |
| 8, 8A | slave data processing device (CPUs) |
| 10 to 15 | bus |
| 20 | peripheral device |
| 21 | peripheral data processing device |
| 22, 23 | bus |

### BEST MODE FOR CARRYING OUT THE INVENTION

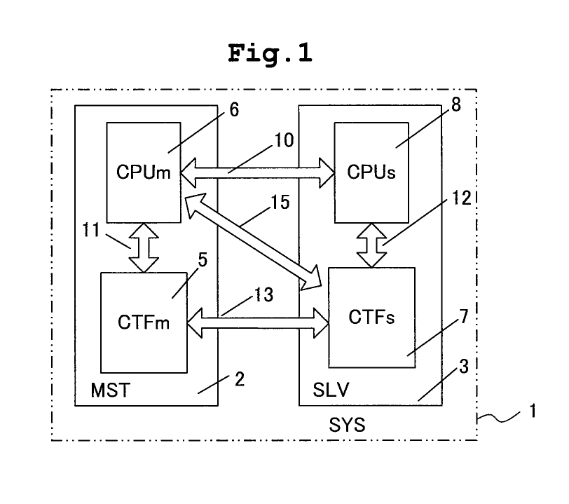

In FIG. 1, an example of a data processing system according to the present invention is shown. A data processing system (SYS) 1 includes a master device (MST)2 and a slave device (SLV) 3 that is detachably coupled to the master device 2. For example, when it is assumed that the master device 2 is a PC that can be driven by a battery, the slave device 3 is the battery. The slave device 3 may be a removable storage, disk drive or the like. Further, the slave device 3 may be a hard disk drive or the like that is attached to a PCI (Peripheral Component Interconnect) bus slot of a PC. In the drawing, there is representatively shown a configuration necessary for device certification to determine that the slave device 3 coupled to the master device 2 in the data processing system 1 is true or correct.

In the master device 2 of FIG. 1, there are representatively shown a master certification device (CTFm) 5 that is used for a certification process for the slave device 3 coupled to the master device 2 and a master data processing device (CPUm) 6 that enables interface control with respect to the slave device 3 coupled to the master device 2 and interface control with respect to the master certification device 5. Illustration of the other configurations of the master device 2 as a PC is omitted. In particular, the master data processing device 6 is not a core processor to perform an arithmetic process in a PC, but is a data processor (not shown) that detects an entry from a key board and controls the rotation of a cooling fan. The data processor is diverted to device certification. In the slave device 3, there are representatively shown a slave certification device (CTFs)7 that is used for a certification process performed by the master device 2 for the slave device and a slave data processing device (CPUs)8 that enables interface control with respect to the master device 2 coupled to the slave device 3 and interface control with respect to the slave certification device 7. Illustration of the other configurations such as a battery of the slave device 3 is omitted. Here, the slave data processing device (CPUs)8 is a processor that obtains performance information such as the number of battery charges and voltage, and controls outputting of attribution information such as a battery ID. The slave data processing device (CPUs)8 is diverted to device certification.

Although not shown in the drawing, the master data processing device 6 includes a CPU (Central Processing Unit), a RAM (Random Access Memory), a ROM (Read Only Memory), and a plurality of ports. The slave data processing device 8 also includes the same elements. The master data processing device 6 and the slave data processing device 8 are mutually coupled to each other through a bus 10 through each port. The master data processing device 6 and the slave data processing device 8 transmit and receive a command and a command response to/from each other through the bus 10. The master certification device 5 is coupled to a specific port of the master data processing device 6 through a bus 11, gives an operation command from the master data processing device 6 to the master certification device 5, and returns a response to the command to the master data processing device 6. As similar to the above, the slave certification device 7 is coupled to a specific port of the slave data processing device 8 through a bus 12, gives an operation command from the slave data processing device 8 to the slave certification device 7, and returns a response to the command to the slave data processing device 8.

Each of the master certification device 5 and the slave certification device 7 includes a random number generating unit, an encryption/decryption unit, a determination unit, and a sequencer, and the same encryption/decryption protocol (certification function) is set to the encryption/decryption unit of each of the master certification device 5 and the slave certification device 7 so as to perform a certification process to be described later. The master certification device 5 and the slave certification device 7 are instructed to operate on the basis of an operation command given from the outside, and returns a response to the command to the outside. However, an operation command that arbitrarily accesses from the outside to the inside is not supported. As the other elements, circuit and physical means that holds confidentiality of the inside may be provided. Each of the master certification device 5, the master data processing device 6, the slave certification device 7, and the slave data processing device 8 is formed as a semiconductor integrated circuit by using an individual chip. The master certification device 5 and the slave certification device 7 are mutually coupled to each other through a bus 13. The master data processing device 6 and the slave certification device 7 are mutually coupled to each other through a bus 15.

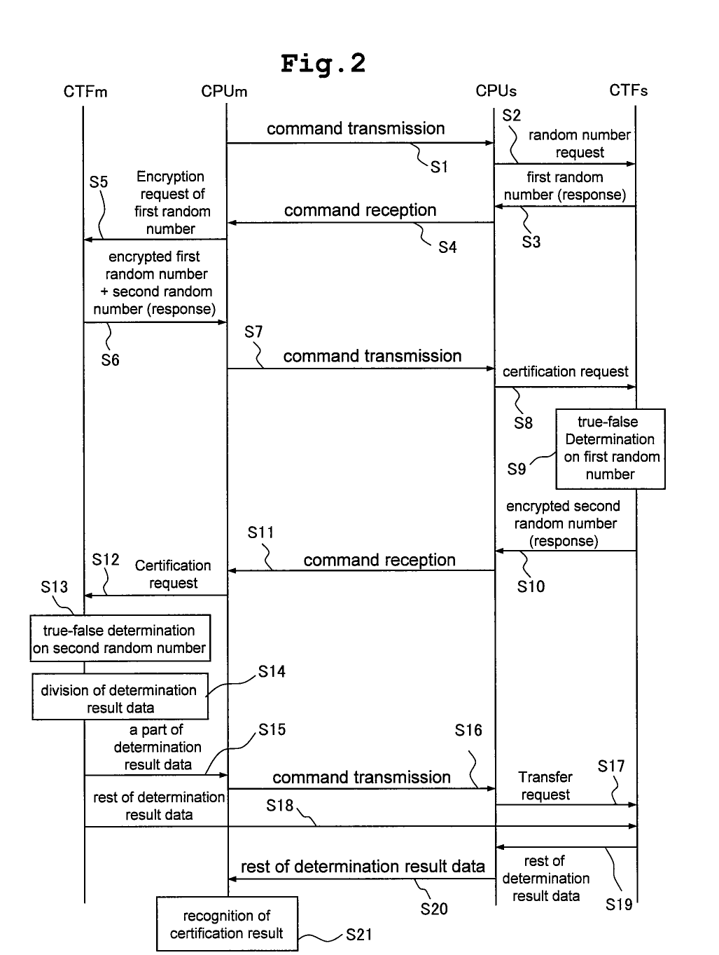

In FIG. 2, a device certification procedure is exemplified. For example, when the slave device 3 is attached to the master device 2, the master data processing device 6 issues a command to the slave data processing device through the bus 10 (S1). The slave data processing device 8 instructs the slave certification device 7 to generate a random number (S2), and a first random number is given to the slave data processing device 8 (S3). The master data processing device 6 receives the first random number from the slave data processing device 8 (S4). The master data processing device 6 instructs the master certification device 5 to encrypt the first random number (S5). In response thereto, the master certification device 5 encrypts the first random number in accordance with a predetermined algorithm and adds a new second random number to the encrypted first random number (S6). The master data processing device 6 transfers the second random number added to the encrypted first random number, together with a command (first command), to the slave data processing device 8 from the bus 10 (S7). The slave data processing device 8 instructs the slave certification device 7 to certify the encrypted data (S8), and the slave certification device 7 determines whether or not the first random number is included in a random number obtained by decrypting the received encrypted-data (S9). When the first random number is included, data obtained by encrypting the second random number added to the encrypted first random number are returned to the slave data processing device 8. When the first random number is not included, data obtained by encrypting a random number different from the second random number added to the encrypted first random number are returned to the slave data processing device 8 (S10). The master data processing device 6 receives the encrypted data from the slave data processing device 8 (S11), and the master data processing device 6 instructs the master certification device 5 to certify the encrypted data (S12). The master certification device 5 determines whether or not the second random number is included in a random number obtained by decrypting the received encrypted-data. If the second random number is included, it is determined as successful certification. If the second random number is not included, it is determines as unsuccessful certification. The master certification device 5 converts the determination result of the successful certification or the unsuccessful certification into code data that are preliminarily determined between the master certification device 5 and the master data processing device 6, and the determination result data are divided (S14). For example, when a value Z is assigned to the successful certification and a value W is assigned to the unsuccessful certification, Xt and Yt are obtained by carrying out an operation to satisfy the relation of Z=aXt+bYt. Each of a and b is an argument that is mutually recognized by the master certification device 5 and the master data processing device 6. One of the divided determination result data is Xt, and the other of the divided determination result data is Yt. For the unsuccessful certification, Xe and Ye are obtained by carrying out an operation to satisfy the relation of W=aXe+bYe.

One of the divided determination result data is Xe, and the other of the divided determination result data is Ye.

One of the divided determination result data is transmitted to the master data processing device 6 from the bus 11 (S15), and the other of the divided determination result data is transmitted to the slave certification device 7 from the bus 13 (S18). When the master certification device 5 transfers one of the divided determination result data to the master data processing device through the bus 11 (S15), the master data processing device 6 that receives a part of the determination result data issues the command (first command) to the slave data processing device 8 (S16), and, in response thereto, the slave data processing device 8 issues a transfer request to the slave certification device 7 (S17). When the other of the determination result data is directly transmitted to the slave certification device 7 from the master certification device 5 through the bus 13 (S18), the slave certification device 7 transfers the same to the slave data processing device 8 (S19), and the slave data processing device 8 returns the other of the divided determination result data being received, as a command response, to the master data processing device from the bus 10 (S20). The master data processing device 6 couples one of the determination result data supplied from the master certification device through the bus 11 in S15 with the other of the determination result data supplied from the slave data processing device 8 through the bus 10 in S20 in accordance with a predetermined algorithm, and accordingly, the certification result for the slave device 3 can be recognized (S21). Post-processing in accordance with the success or the unsuccess of the recognized certification result is appropriately determined by an operation program for a different data processing device in the master data processing device 6 or the master device 2. When it is determined as unsuccess in the true-false determination of S9, the master data processing device 6 receives the result as a command response from the slave data processing device 8, so that the process may be shifted to the one for the unsuccessful certification.

According to this procedure, the certification result obtained by the master device 2 for the slave device 3 is notified to the master data processing device 6 while coupling one of the determination result data supplied from the master certification device 5 to the master data processing device 6 through the bus 11 with the other of the determination result data supplied from the master certification device 5 to the master data processing device 6 through the bus 13, the slave device 3, and the bus 10. Even when one of the determination result data and the other of the determination result data are plain text, they are given from different routes. Accordingly, the confidentiality for the determination result can be enhanced as compared to the case where all of the determination results are given from the master certification device 5 to the master data processing device 6. Thus, it is not necessary to enhance the confidentiality for the determination result of the certification process by allowing the master data processing device 6 to execute an encryption/decryption processing program. Accordingly, it is not necessary for the master data processing device 6 to execute the encryption/decryption processing program, so that a burden on the data processing is not increased and a storing area for such a program does not need to be secured. Further, one of the different routes through which the determination result data are given to the master data processing device 6 is the internal bus 11 of the master device 2, and the both of one and the other of the determination result data are not given to the master data processing device 6 from the slave device 3. If the both are given to the master data processing device 6 from the slave device 3, illegal replication or imitation can be done only on the side of the slave device 3 as a demonstrator to be certified. Thus, the certification result that means approval can be fabricated and input to the master device irrespective of the actual certification result. Such a situation can be also prevented.

There are separately provided the bus 13 through which the other of the determination result data obtained by the master certification device 5 is transferred to the slave device 3 and the bus 10 through which the other of the determination result data is returned from the slave device 3. The same determination result data do not pass through the same route such as the bus 10, so that the confidentiality for the determination result data themselves can be enhanced.

The bus 10 is a general-purpose bus through which a command from the master data processing device 6 is transmitted and a response from the slave device 3 responding to the command is transmitted. Thus, a different command or command response can be provided at the head or rear of the determination result data. For example, the other of the determination result data that is returned from the slave device 3 through the bus 10 may be accompanied with dummy data. In addition, the other of the determination result data that is returned from the slave device 3 through the bus 10 may be accompanied with a response to a different command. In this respect, too, the confidentiality for the determination result data themselves can be enhanced. Accordingly, it becomes difficult to illegally discriminate the other of the determination result data on the bus 10. When accompanying the dummy data and the different command response, the master device 2 and the slave device 3 share a predetermined algorithm for them, and perform the algorithm to be satisfied.

In the data processing system of FIG. 1, the processing procedure may be changed in such a manner that the slave certification device 7 that receives, through the bus 13, the other of the determination result data obtained by dividing the true-false determination result obtained by the master certification device 5 directly returns the other of the determination result data to the master data processing device 6 through the bus 15. Specifically, the slave data processing device 8 that responds to the command of S16 from the master data processing device 6 allows the slave certification device 7 to supply the other of the divided determination result data to the master data processing device 6 through the bus 15.

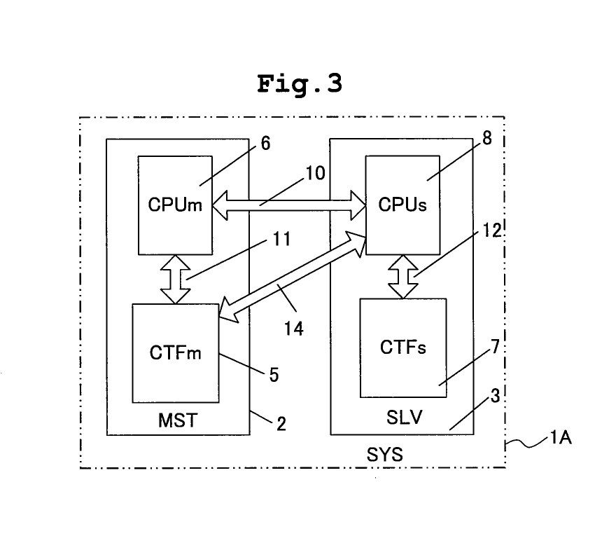

In FIG. 3, another example of a data processing system is shown. A data processing system 1A shown in the drawing transfers a part of the determination result data obtained by dividing the true-false determination result obtained by the master certification device 5 to the slave data processing device 8 from the bus 14. Specifically, the slave data processing device 8 that responds to the command of S16 from the master data processing device 6 directly receives a part of the divided determination result data from the master certification device 5 through the bus 14 and supplies the same to the master data processing device 6. The constituent elements having the same functions as those in FIG. 1 are given the same reference numerals, and the detailed explanation thereof will not be repeated.

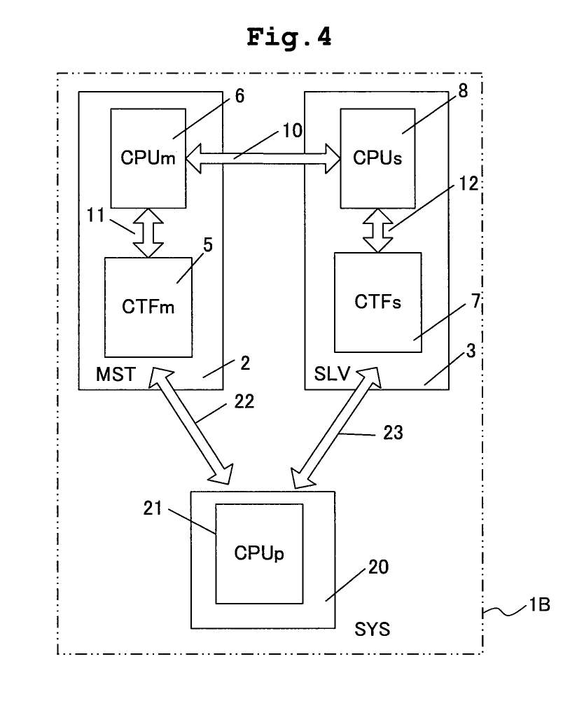

In FIG. 4, still another example of a data processing system is shown. A data processing system 1B shown in the drawing includes, in addition to the master device 2 and the slave device 3, a peripheral device 20 that can be coupled to the master device 2 and the slave device 3. When it is assumed that the master device 2 is a PC and the slave device 3 is a battery, the peripheral device 20 is, for example, a hard disk unit, or a removable flash memory card. The peripheral device 20 includes, for example, a drive or a memory (not shown), and a peripheral data processing device (CPUp) 21 that controls the drive or the memory. One port of the peripheral data processing device 21 is coupled to the master certification device 5 through a bus 22, and a different port thereof is coupled to the slave certification device 7 through a bus 23. The master certification device 5 outputs the other of the determination result data obtained by dividing the determination result data of S14 to the peripheral device 20 through the bus 22, and outputs one of the determination result data to the master data processing device 6 through the bus 11. The peripheral device 20 outputs the other of the determination result data received through the bus 22 to the slave certification device 7 through the bus 23. The certification process and the other procedures are the same as those in FIG. 1. The constituent elements having the same functions as those in FIG. 1 are given the same reference numerals, and the detailed explanation thereof will not be repeated. By providing the peripheral device 20 on the transfer route through which the other of the divided determination result data is transmitted from the master device 2 to the slave device 3, the route becomes more complicated. In this respect, the confidentiality for the determination result data themselves can be enhanced.

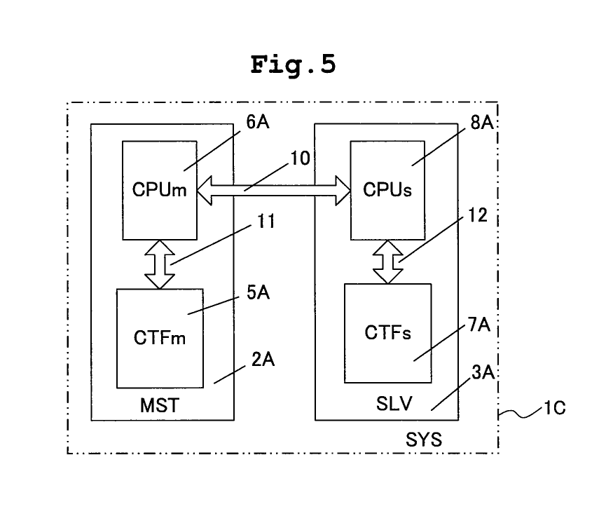

In FIG. 5, still another example of a data processing system is shown. A data processing system 1C shown in the drawing enhances the confidentiality particularly for the mutual-certification result. A master data processing device 6A and a slave data processing device 8A serve as interfaces between a master device 2A and a slave device 3A through a bus 10. As similar to the above description, the master device 2A includes a master certification device (CTFm) 5A that generates and converts certification data and makes a true-false determination on the certification data, and a master data processing device (CPUm) 6A that enables interface control with respect to the slave data processing device (CPUs) 8A and the master certification device 5A. The slave device 3A includes a slave certification device (CTFs) 7A that generates and converts certification data and makes a true-false determination on the certification data, and a slave data processing device (CPUs) 8A that enables interface control with respect to the master data processing device 6A and the slave certification device 7A. The slave certification device 7A makes a true-false determination on a first conversion data (encrypted data of a first random number) that is returned after generated first certification data (first random number) are converted (encrypted) by the master certification device 5A. The master certification device 5A makes a true-false determination on a second conversion data (encrypted data of a second random number) that is returned after generated second certification data (second random number) are converted (encrypted) by the slave certification device 7A. The master data processing device 6A performs an operation using a first true-false determination result obtained by the slave certification device 7A for the first conversion data and a second true-false determination result obtained by the master certification device 5A for the second conversion data, so as to obtain a certification result for the slave device 3A. For example, when it is assumed that the first true-false determination result data X is represented as Xt when the first true-false determination result is “true”, the first true-false determination result data X is represented as Xe when the first true-false determination result is “false”, the second true-false determination result data Y is represented as Yt when the second true-false determination result is “true”, and the second true-false determination result data Y is represented as Ye when the second true-false determination result is “false”, it is determined as successful certification for the slave device as long as αX+βY=αXt+βYt=Zt. It is determined as unsuccessful certification unless the result is Zt. The other configurations are the same as those in FIG. 1, and thus, the detailed explanation thereof will not be repeated.

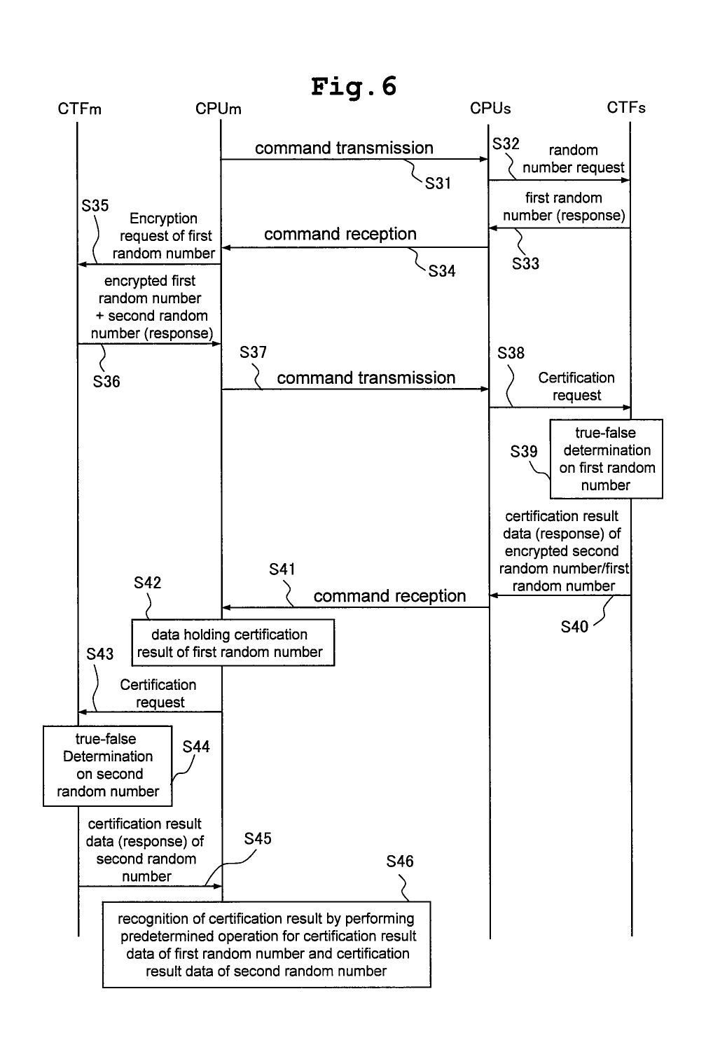

In FIG. 6, a device certification procedure in the data processing system of FIG. 5 is exemplified. For example, when the slave device 3A is attached to the master device 2A, the master data processing device 6A issues a command to the slave data processing device 8A through the bus 10 (S31). The slave data processing device 8A instructs the slave certification device 7A to generate a random number (S32), and a first random number (first certification data) is given to the slave data processing device 8A (S33). The master data processing device 6A receives the first random number from the slave data processing device 8A (S34). The master data processing device 6A instructs the master certification device 5A to encrypt the first random number (S35). In response thereto, the master certification device 5A encrypts (converts) the first random number in accordance with a predetermined algorithm and adds a new second random number (second certification data) to the encrypted first random number (S36). The master data processing device 6A transfers the second random number added to the encrypted first random number, together with a command, to the slave data processing device BA from the bus 10 (S37) The slave data processing device 8A instructs the slave certification device 7A to certify the encrypted data (first conversion data) (S38), and the slave certification device 7A makes a true-false determination of whether or not the first random number is included in a random number obtained by decrypting the received encrypted-data (S39). When the first random number is included, the true-false determination result is “true”, and when the first random number is not included, the true-false determination result is “false”. The true-false determination result serves as first true-false determination result data having a code corresponding to “true” or “false”. When the first random number is included, the first true-false determination result data corresponding to “true” and data (second conversion data) obtained by encrypting the second random number added to the encrypted first random number (first conversion data) are returned to the slave data processing device 8A. When the first random number is not included, the first true-false determination result data corresponding to “false” and the data (second conversion data) obtained by encrypting the second random number added to the encrypted first random number (first conversion data) are returned to the slave data processing device 8A (S40). The master data processing device 6A receives the first true-false determination result data and the encrypted second conversion data from the slave data processing device 8A (S41), and the master data processing device 6A holds the first true-false determination result data in an internal register or the like (S42), and instructs the master certification device 5A to make a true-false determination on the second conversion data (S43). The master certification device 5A makes a true-false determination of whether or not the second random number is included in a random number obtained by decrypting the received second conversion data (S44). When the second random number is included, the true-false determination result is “true”, and when the second random number is not included, the true-false determination result is “false”. The true-false determination result serves as second true-false determination result data having a code corresponding to “true” or “false”. When the second random number is included, the second true-false determination result data corresponding to “true” are returned to the master data processing device 6A. When the second random number is not included, the second true-false determination result data corresponding to “false” are returned to the master data processing device 6A (S45). The master data processing device 6A performs an operation using the first true-false determination result data obtained by the slave certification device 7A for the first conversion data and the second true-false determination result data obtained by the master certification device 5A for the second conversion data to obtain a certification result for the slave device 3A. The content of the operation is not limited to the above-described operation, but can be appropriately changed. In relation to lightening of a burden on the software processing, for example, an integer arithmetic is desirable.

According to this procedure, although the certification performed by the master device 2A for the slave device 3A is mutually performed by a certification process performed by the slave device 3A for the master device 2A and a certification process performed by the master device 2A for the slave device 3A, it is possible for the master data processing device 6A to obtain the certification result for the slave device 3A by performing an operation using the true-false determination data results obtained by the respective certification processes. The respective pieces of true-false determination result data are serially given from different routes of the buses 10 and 11, and the both pieces of true-false determination result data are used for the final certification, so that the confidentiality for the determination result can be enhanced as compared to the mutual certification separately using the respective determination results. It is not necessary to enhance the confidentiality for the determination result of the certification process by allowing the master data processing device to execute the encryption/decryption processing program.

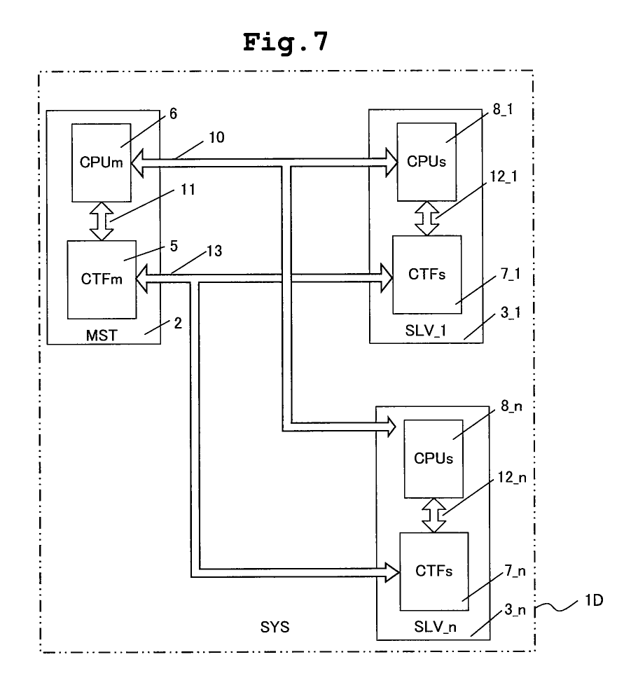

In FIG. 7, still another example of a data processing system is shown. A data processing system 1D shown in the drawing is different from the configuration of FIG. 1 in that a plurality of slave devices 3_1 to 3_n are coupled to one master device 2. In this case, the master data processing device 6 sequentially selects the slave devices 3_1 to 3_n one by one to perform certification. In order to select the slave device, the master device 2 issues a command to which an address or an ID for designating the slave device is given, allows the slave device to recognize the command, and the designated slave device responds to the command. Although not particularly shown in the drawing, the number of slave devices coupled to the master device can be increased in each of the data processing systems of FIG. 3 to 5, as similar to FIG. 7.

The invention achieved by the inventors has been described above in detail on the basis of the embodiment. However, it is obvious that the invention is not limited to the embodiment, but may be variously changed within a scope without departing from the gist of the invention. The original functions and configurations of the master device and the slave device are not limited to the above description, but may be appropriately changed.

### INDUSTRIAL APPLICABILITY

The present invention can be widely applied to device certification between a laser beam printer and a toner cartridge and between a portable music player and its battery, in addition to device certification between a PC and a battery.

1. A master device to which a slave device is detachably coupled, the master device comprising:
a master certification device which is used for a certification process for the coupled slave device; and
a master data processing device which enables interface control with respect to the coupled slave device and interface control with respect to the master certification device,
wherein the master certification device makes a true-false determination on a response which is returned from the slave device after responding to a command from the master data processing device, divides a true-false determination result into a plurality of pieces of determination result data in accordance with a predetermined algorithm, outputs a part of the divided determination result data to the slave device, and outputs the rest to the master data processing device, and
wherein the master data processing device recognizes the determination result on the basis of the part of the determination result data which is returned from the slave device and the rest of the determination result data which is given from the master certification device.

2. The master device according to claim 1, separately comprising a first transfer route through which the part of the determination result data obtained by the master certification device is transferred to the slave device, and a second transfer route through which the part of the determination result data is returned from the slave device.

3. The master device according to claim 2,
wherein the second transfer route is a general-purpose bus through which a command from the master data processing device is transmitted and a response from the slave device responding to the command is transmitted.

4. The master device according to claim 3,
wherein the part of the determination result data which is returned from the slave device through the general-purpose bus is accompanied with dummy data.

5. The master device according to claim 3,
wherein the part of the determination result data which is returned from the slave device through the general-purpose bus is accompanied with a response to a different command.

6. A data processing system comprising:
a master device; and
a slave device which is detachably coupled to the master device,
wherein the master device includes:
a master certification device which is used for a certification process for the coupled slave device; and
a master data processing device which enables interface control with respect to the coupled slave device and interface control with respect to the master certification device,
wherein the master certification device makes a true-false determination on a response which is returned from the slave device after responding to a command from the master data processing device, divides a true-false determination result into a plurality of pieces of determination result data in accordance with a predetermined algorithm, outputs a part of the divided determination result data to the slave device, and outputs the rest to the master data processing device, and
wherein the master data processing device recognizes the determination result on the basis of the part of the determination result data which is returned from the slave device and the rest of the determination result data which is given from the master certification device.

7. The data processing system according to claim 6, separately comprising a first transfer route through which the part of the determination result data obtained by the master certification device is transferred to the slave device, and a second transfer route through which the part of the determination result data is returned from the slave device.

8. The data processing system according to claim 7,
wherein the second transfer route is a general-purpose bus through which a command from the master data processing device is transmitted and a response from the slave device responding to the command is transmitted.

9. The data processing system according to claim 8,
wherein the slave device allows the part of the determination result data which is returned to the master device through the general-purpose bus to be accompanied with dummy data.

10. The data processing system according to claim 8,
wherein the slave device allows the part of the determination result data which is returned to the slave device through the general-purpose bus to be accompanied with a response to a different command.

11. The data processing system according to claim 6,
wherein the slave device includes:
a slave certification device which is used for a certification process performed by the master device for the slave device; and
a slave data processing device which enables interface control with respect to the master device to which the slave device is coupled and interface control with respect to the slave certification device,
wherein, in response to a first command from the master device, the slave certification device generates response data, and the slave data processing device outputs the response data to the master device, and
wherein, in response to a second command from the master device, the slave certification device inputs a part of determination result data which are obtained by dividing a true-false determination result by the master device on the basis of the response data, and the slave data processing device returns the part of the determination result data to the master device.

12. The data processing system according to claim 6,
wherein the slave device includes:
a slave certification device which is used for a certification process performed by the master device for the slave device; and
a slave data processing device which enables interface control with respect to the master device to which the slave device is coupled and interface control with respect to the slave certification device,
wherein, in response to a first command from the master device, the slave certification device generates response data, and the slave data processing device outputs the response data to the master device, and
wherein, in response to a second command from the master device, the slave certification device inputs a part of determination result data which are obtained by dividing a true-false determination result by the master device on the basis of the response data, and the slave certification device returns the part of the determination result data to the master device.

13. The data processing system according to claim 6,
wherein the slave device includes:
a slave certification device which is used for a certification process performed by the master device for the slave device; and
a slave data processing device which enables interface control with respect to the master device to which the slave device is coupled and interface control with respect to the slave certification device,
wherein, in response to a first command from the master device, the slave certification device generates response data, and the slave data processing device outputs the response data to the master device, and
wherein, in response to a second command from the master device, the slave data processing device inputs a part of determination result data which are obtained by dividing a true-false determination result by the master device on the basis of the response data, and the slave data processing device returns the part of the determination result data to the master device.

14. The data processing system according to claim 11,
wherein the slave device separately includes a first interface terminal to which the part of the divided determination result data is input from the master device, and a second interface terminal from which the part of the divided determination result data input from the first interface terminal is output to the master device.

15. The data processing system according to claim 14,
wherein the second interface terminal is a general-purpose terminal which is used for inputting a command from the master device and for outputting a command response.

16. The data processing system according to claim 15,
wherein the part of the divided determination result data which is returned to the master device through the general-purpose terminal is accompanied with dummy data.

17. The data processing system according to claim 15,
wherein the part of the divided determination result data which is returned to the master device through the general-purpose terminal is accompanied with a different command response.

18. A data processing system comprising:
a master device;
a slave device which is detachably coupled to the master device; and
a peripheral device which can be coupled to the master device and the slave device,
wherein the master device includes:
a master certification device which is used for a certification process for the coupled slave device; and
a master data processing device which enables interface control with respect to the coupled slave device and interface control with respect to the master certification device,
wherein the master certification device makes a true-false determination on a response which is returned from the slave device after responding to a command from the master data processing device, divides a true-false determination result into a plurality of pieces of determination result data in accordance with a predetermined algorithm, outputs a part of the divided determination result data to the peripheral device, and outputs the rest to the master data processing device,
wherein the peripheral device outputs the part of the divided determination result data to the slave device, and
wherein the master data processing device recognizes the determination result on the basis of the part of the determination result data which is returned from the slave device and the rest of the determination result data which is given from the master certification device.

19. A master device to which a slave device is detachably coupled, the master device comprising:
a master certification device which generates and converts certification data and makes a true-false determination on the certification data; and
a master data processing device which enables interface control with respect to the slave device and the master certification device,
wherein the master certification device makes a true-false determination on response data from the slave device responding to the generated certification data, divides a determination result into first and second determination result data, outputs the first determination result data to the slave device, and outputs the second determination result data to the master data processing device, and
wherein the master data processing device recognizes the determination result on the basis of the first determination result data which are received from the slave device and the second determination result data which are received from the master certification device.

20. A data processing system comprising:
a master device; and
a slave device which is detachably coupled to the master device,
wherein the master device includes:
a master certification device which generates and converts certification data and makes a true-false determination on the certification data; and
a master data processing device which enables interface control with respect to the slave device and the master certification device,
wherein the slave device includes:
a slave certification device which generates and converts certification data and makes a true-false determination on the certification data; and
a slave data processing device which enables interface control with respect to the master device and the slave certification device,
wherein the master certification device makes a true-false determination on conversion data which are returned after the generated certification data are converted by the slave certification device, divides a determination result into first and second determination result data, outputs the first determination result data to the slave device, and outputs the second determination result data to the master data processing device, and
wherein the master data processing device recognizes the determination result on the basis of the first determination result data which are received from the slave device and the second determination result data which are received from the master certification device.

21. A data processing system comprising:
a master device; and
a slave device which is detachably coupled to the master device,
wherein the master device includes:
a master certification device which generates and converts certification data and makes a true-false determination on the certification data; and
a master data processing device which enables interface control with respect to the slave device and the master certification device,
wherein the slave device includes:
a slave certification device which generates and converts certification data and makes a true-false determination on the certification data; and
a slave data processing device which enables interface control with respect to the master device and the slave certification device,
wherein the slave certification device makes a true-false determination on first conversion data which are returned after generated first certification data are converted by the master certification device,
wherein the master certification device makes a true-false determination on second conversion data which are returned after generated second certification data are converted by the slave certification device, and
wherein the master data processing device obtains a certification result for the slave device by performing an operation using a first true-false determination result obtained by the slave certification device for the first conversion data and a second true-false determination result obtained by the master certification device for the second conversion data.

22. A data processing system comprising:
a master device; and
a slave device which is detachably coupled to the master device,
wherein the master device includes:
a master certification device which generates and converts certification data and makes a true-false determination on the certification data; and
a master data processing device which enables interface control with respect to the slave device and the master certification device,
wherein the slave device includes:
a slave certification device which generates and converts certification data and makes a true-false determination on the certification data; and
a slave data processing device which enables interface control with respect to the master device and the slave certification device,
wherein the slave certification device makes a true-false determination on first conversion data which are returned after generated first certification data are converted by the master certification device,
wherein the master certification device makes a true-false determination on second conversion data which are returned after generated second certification data are converted by the slave certification device,
wherein the slave data processing device gives a first true-false determination result obtained by the slave certification device for the first conversion data to the master data processing device, and
wherein the master data processing device obtains a certification result for the slave device by performing an operation using a second true-false determination result for the second conversion data which are received from the master certification device and the first true-false determination result which are received from the slave data processing device.

23. A data processing system comprising:
a master device; and
a slave device which is detachably coupled to the master device,
wherein the master device includes:
a master certification device which generates and converts certification data and makes a true-false determination on the certification data; and
a master data processing device which enables interface control with respect to the slave device and the master certification device,
wherein the slave device includes:
a slave certification device which generates and converts certification data and makes a true-false determination on the certification data; and
a slave data processing device which enables interface control with respect to the master device and the slave certification device,
wherein the master data processing device converts first certification data generated by the slave certification device at the master certification device, and adds second certification data generated by the master certification device to the converted first-conversion-data to be output to the slave data processing device,
wherein the slave processing device allows the slave certification device to make a true-false determination on the first conversion data of the first certification data and to convert the second certification data, and outputs the determined first-determination-result-data and the converted second-conversion-data to the master data processing device, and
wherein the master data processing device allows the master certification device to make a true-false determination on the second conversion data of the second certification data, and obtains a determination result for the slave device on the basis of the determined second-determination-result-data and the determined first-determination-result-data.

24. The data processing system according to claim 12,
wherein the slave device separately includes a first interface terminal to which the part of the divided determination result data is input from the master device, and a second interface terminal from which the part of the divided determination result data input from the first interface terminal is output to the master device.

25. The data processing system according to claim 24,
wherein the second interface terminal is a general-purpose terminal which is used for inputting a command from the master device and for outputting a command response.

26. The data processing system according to claim 25,
wherein the part of the divided determination result data which is returned to the master device through the general-purpose terminal is accompanied with dummy data.

27. The data processing system according to claim 25,
wherein the part of the divided determination result data which is returned to the master device through the general-purpose terminal is accompanied with a different command response.

28. The data processing system according to claim 13,
wherein the slave device separately includes a first interface terminal to which the part of the divided determination result data is input from the master device, and a second interface terminal from which the part of the divided determination result data input from the first interface terminal is output to the master device.

29. The data processing system according to claim 28,
wherein the second interface terminal is a general-purpose terminal which is used for inputting a command from the master device and for outputting a command response.

30. The data processing system according to claim 29,
wherein the part of the divided determination result data which is returned to the master device through the general-purpose terminal is accompanied with dummy data.

30. The data processing system according to claim 29, wherein the part of the divided determination result data which is returned to the master device through the general-purpose terminal is accompanied with a different command response.
